(19) United States
(12) Patent Application Publication
(10) Pub. No.: US 2008/0263222 A1
(43) Pub. Date: Oct. 23, 2008

(54) COMPUTER SYSTEM, ROOT NODE, AND LOG MANAGEMENT METHOD FOR ACCESS PATH CONVERSION

(76) Inventors: Keiichi MATSUZAWA, Yokohama (JP); Etsutaro AKAGAWA, Kawasaki (JP); Koji SONODA, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,737

(22) Filed: Jan. 3, 2008

(30) Foreign Application Priority Data
Apr. 20, 2007 (JP) 2007-111549

(51) Int. Cl. G06F 15/173

(52) U.S. Cl. 709/238

(57) ABSTRACT

A computer system including a storage system, a host computer system, a path configuration unit that associates a local path with a global path, an access path conversion unit that converts a global path into a local path associated, by the path configuration unit, with the global path used in the file access, and forwards the converted file access to the storage system, an access log reception unit that receives an access log from the storage system, an access log conversion unit that converts the local path used in the access log received by the access log reception unit, into a global path associated, by the path configuration unit, with the local path used in the received access log, and an access log display unit that displays the converted access log.

### CROSS-REFERENCE TO RELATED APPLICATIONS

The present application claims the priority based on Japanese Patent Application No. 2007-111549 filed on Apr. 20, 2007, the disclosure of which is hereby incorporated by reference in its entirety.

### BACKGROUND

1. Technical Field

The present invention relates to storage technology for management of file data stored in a computer system, and in particular relates to log management technology for management of an access log that records file access.

2. Related Art

Some computer systems to employ a global name space (hereinafter also denoted as GNS) to manage in unified fashion the access paths from a host computer system to a storage system. In a global name space, the real local paths that lead to files stored in the storage system are associated with virtual global paths. Consequently, file access from the host computer system can be made without having to modify the access paths, even if the physical access path configuration to the storage system is modified. By means of a global name space, file accesses processed using global paths from the host computer system can be handled on the storage system end, in the same manner as file access processed using local paths. JP A-2003-203029 discloses a computer system constituting a global name space.

### SUMMARY

With the global name spaces discussed above, since the access log which records file access history is created on the storage system end, using local paths, it is difficult to analyze the access log from the host computer system, which uses global paths.

With the foregoing in view, it is an object of the invention to provide a storage technology whereby the analysis process of the access log in a global name space can be carried out easily.

The invention is intended to address this issue at least in part, and can be reduced to practice as described in the following embodiments and application examples.

A computer system according to an aspect of the invention is a computer system comprising: a storage system for storing data as a file; a host computer system that performs file access to the storage system; a path configuration unit that associates a local path with a global path, wherein the local path represents a location of the file stored in the storage system, and the global path represents a virtual location of the stored file to the host computer system; an access path conversion unit that converts a global path used in the file access from the host computer system, into a local path associated, by the path configuration unit, with the global path used in the file access, and forwards the converted file access to the storage system; an access log reception unit that receives an access log using the local path from the storage system after the converted file access is forwarded to the storage system, wherein the access log represents execution record of the forwarded file access; an access log conversion unit that converts the local path used in the access log received by the access log reception unit, into a global path associated, by the path configuration unit, with the local path used in the received access log; and an access log display unit that displays the access log converted from the local path into the global path by the access log conversion unit.

According the computer system described above, the displayed access log will have been converted from local paths to global paths, and therefore the analysis process of the access log in a global name space using global paths can be carried out easily.

A root node according to an aspect of the invention is a root node relaying file access from a host computer system to a storage system, the root node comprising: a path configuration unit that associates a local path with a global path, wherein the local path represents a location of the file stored in the storage system, and the global path represents a virtual location of the stored file to the host computer system; an access path conversion unit that converts a global path used in the file access from the host computer system, into a local path associated, by the path configuration unit, with the global path used in the file access, and forwards the converted file access to the storage system; an access log reception unit that receives an access log using the local path from the storage system after the converted file access is forwarded to the storage system, wherein the access log represents execution record of the forwarded file access; an access log conversion unit that converts the local path used in the access log received by the access log reception unit, into a global path associated, by the path configuration unit, with the local path used in the received access log; and an access log display unit that displays the access log converted from the local path into the global path by the access log conversion unit.

According the root node described above, an access log converted from local paths to global paths is accumulated in a log management unit, whereby the analysis process of the access log in a global name space using global paths can be carried out easily.

A log management method according to an aspect of the invention is a log management method for managing an access log representing execution of file access from a host computer system to a storage system, the log management method comprising: (a) storing a path configuration table for associating a local path with a global path, in a root node that relays file access from the host computer system to the storage system, wherein the local path represents a location of the file stored in the storage system, the global path represents a virtual location of the stored file to the host computer system; (b) converting, on the root node, a global path used in the file access from the host computer system, into a local path associated, by the path configuration table, with the global path used in the file access, to forward the converted file access to the storage system; (c) receives an access log using the local path from the storage system after the converted file access is forwarded to the storage system, wherein the access log represents execution record of the forwarded file access; (d) converting the local path used in the received access log, into a global path associated, by the path configuration table, with the local path used in the received access log; and (e) displaying the access log converted from the local path into the global path.

According the log management method described above, the displayed access log will have been converted from local paths to global paths, and therefore the analysis process of the access log in a global name space using global paths can be carried out easily.

The embodiments of the present are not limited to those of a computer system, a root node, and a log management method, and can be reduced to practice in possible as well, for example: various devices making up a computer system; as well as programs for implementing by means of a computer at least some of the functions of these devices; or a recording medium having recorded thereon in computer-readable form at least some of these programs. However, the invention is in no wise limited to the embodiments listed above, and can be reduced to practice in various other ways without departing from the spirit of the invention.

These and other objects, features, aspects, and advantages of the invention will become more apparent from the following detailed description of the preferred embodiments with the accompanying drawings.

### BRIEF DESCRIPTION OF THE DRAWINGS

The invention will be described with reference to the accompanying drawings in which:

FIG. 1 is an illustration depicting functionally a simplified configuration of a computer system;

FIG. 2 is an illustration primarily depicting the specific configuration of the host computer system in the computer system;

FIG. 3 is an illustration primarily depicting the specific configuration of the root node in the computer system;

FIG. 4 is an illustration depicting an exemplary GNS configuration table managed by the root node;

FIG. 5 is an illustration depicting in model form associations between the GNS and the LNS;

FIG. 6 is an illustration depicting an exemplary request forwarding table managed by the root node;

FIG. 7 is an illustration primarily depicting the specific configuration of a leaf node in the computer system;

FIG. 8 is an illustration primarily depicting the specific configuration of a storage unit in the computer system;

FIG. 9 is an illustration depicting in detail the log management unit in the computer system;

FIG. 10 is a flowchart depicting a log creation process executed by the leaf node in the computer system;

FIG. 11 is an illustration depicting an exemplary access log created by the leaf node;

FIG. 12 is a flowchart depicting a log substitution process executed by the root node in the computer system;

FIG. 13 is a flowchart depicting the access source substitution process executed by the root node in the computer system;

FIG. 14 is a flowchart depicting the file path substitution process executed by the root node in the computer system;

FIG. 15 is an illustration depicting an example of an access log that has been substituted by the root node;

FIG. 16 is a flowchart depicting a log display process executed by the log management unit in Embodiment 2;

FIG. 17 is an illustration depicting an example of an unconverted log accumulated in the log accumulation table of the log management unit in Embodiment 2; and

FIG. 18 is an illustration depicting a converted log derived by conversion from the unconverted log of FIG. 17, by the log display process.

### DESCRIPTION OF THE PREFERRED EMBODIMENTS

In order to provide a fuller understanding of the constitution and operation of the invention set forth hereinabove, a computer system in which the invention is implemented will be discussed below.

### A. Embodiment 1

A1. Configuration of Computer System:

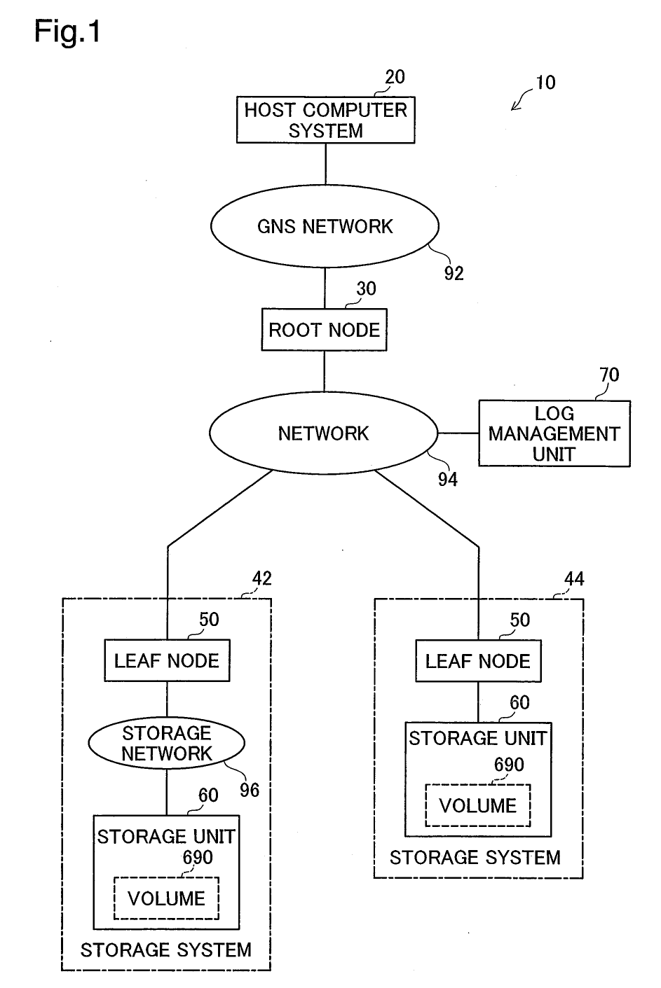

FIG. 1 is an illustration depicting functionally a simplified configuration of a computer system 10. The computer system 10 has a host computer system 20 for processing data; a root node 30 for providing the host computer system 20 with a global name space (GNS); storage units 60 constituting volumes 690 for data storage; leaf nodes 50 for managing data storage in the storage units 60; and a log management unit 70 for managing an access log that records file accesses to the volumes 690 from the host computer system 20. In FIG. 1, with a view to keeping the drawing simple only a single host computer system 20 is shown, but in actual practice the computer system 10 could be provided with a number of host computer systems 20.

The computer system 10 is also furnished with a GNS network 92 linking the host computer system 20 and the root node 30 so as to enable data communication between them; and a network 94 linking the root node 30, the leaf nodes 50, and the log management unit 70 so as to enable data communication among them. On the GNS network 92 there is created a global name space in which file accesses are processed using GNS paths (global paths) that point to virtual locations of files; while on the network 94 there is created a local name space (LNS) in which file accesses are processed using local paths that point to real locations of files. In the present embodiment, the GNS network 92 and the network 94 are constituted as physically separate networks; however, as another embodiment the GNS network 92 could be set up virtually on the network 94 by the root node 30. In the present embodiment, data communications over the GNS network 92 and the network 94 are based on TCP/IP (Transmission Control Protocol/Internet Protocol) standard.

The storage units 60 and the leaf nodes 50 constitute storage systems 42, 44 that save files in the volumes 690 in response to file accesses from the host computer system 20 via the root node 30. The storage system 42 is a system in which the storage unit 60 is connected to the leaf node 50 via a storage network 96, while the storage system 44 is a system in which the storage unit 60 is connected directly to the leaf node 50. In the present embodiment, data communication in the storage network 96 is based on the iSCSI (Internet Small Computer System Interface) standard using TCP/IP; however, as another embodiment data communication could be based on the Fibre Channel (FC) standard. In FIG. 1, with a view to keeping the drawing simple only a single storage unit 60 is shown in the storage system 42, but in actual practice storage system 42 could be provided with a number of storage units 60.

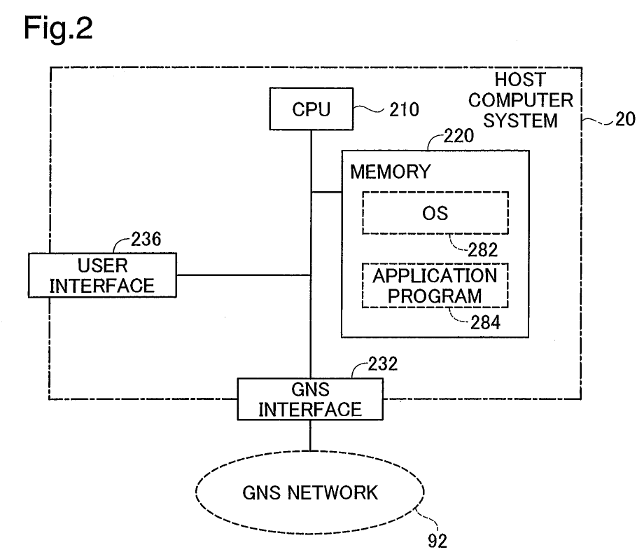

FIG. 2 is an illustration primarily depicting the specific configuration of the host computer system 20 in the computer system 10. The host computer system 20 has a central processing unit (hereinafter CPU) 210 for controlling the various parts of the host computer system 20; a memory 220 for saving data handled by the CPU 210; a GNS interface 232 for file access via the root node 30 through the GNS network 92; and a user interface 236 for exchange of data with the user. In the present embodiment, the user interface 236 of the host computer system 20 includes a keyboard and mouse for accepting input from the user, and a display for displaying images to the user. The memory 220 of the host computer system 20 stores, as programs for operating the CPU 210, an operating system (OS) 282, as well as an application program 284. In the present embodiment, file access to the volumes 690 from the host computer system 20 is implemented through operation of the CPU 210 in accordance with the OS 282 using the memory 220; however, as another embodiment, it could be implemented instead through operation of the CPU 210 in accordance with the application program 284.

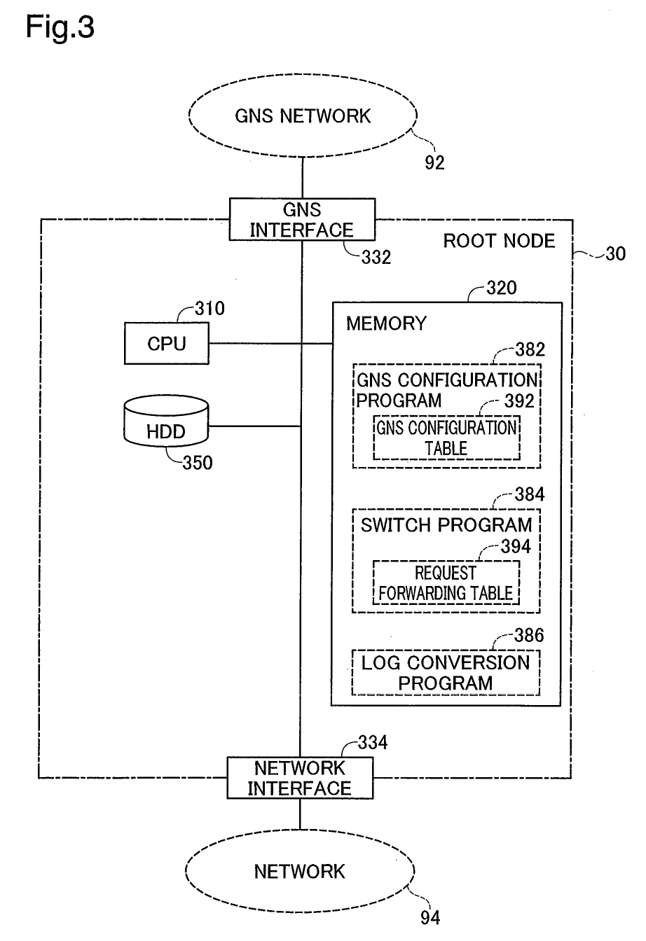

FIG. 3 is an illustration primarily depicting the specific configuration of the root node 30 in the computer system 10. The root node 30 is a device also termed a virtualization device, a switch, or a storage system. The root node 30 has a CPU 310 for controlling the various parts of the root node 30; a memory 320 for saving data handled by the CPU 310; a hard disk drive (HDD) 350 for storing data handled by the CPU 310; a GNS interface 332 for exchange of data with the host computer system 20 via the GNS network 92; and a network interface 334 for exchange of data via the network 94. In the memory 320 of the root node 30 are saved a GNS configuration table 392 that lists associations between GNS paths and local paths, and a request forwarding table 394 that lists forwarding destinations on the local name space forwarding the access request from the host computer system 20. Also saved in the memory 320 of the root node 30, as programs for operating the CPU 310, are a GNS configuration program 382 that configures the global name space on the basis of the GNS configuration table 392, a switch program 384 that switches the pathway for forwarding access requests from the host computer system 20 to the volumes 690 on the basis of the request forwarding table 394, and a log conversion program 386 that converts access logs generated the leaf nodes 50 to a format corresponding to the global name space. In the present embodiment, the data stored in the GNS configuration table 392 and the request forwarding table 394 is set through an administrative unit (not shown) that accepts input of instructions by the administrator of the computer system 10; some of this data can be modified by means of commands from the host computer system 20. The operation of the root node 30 will be discussed in detail later.

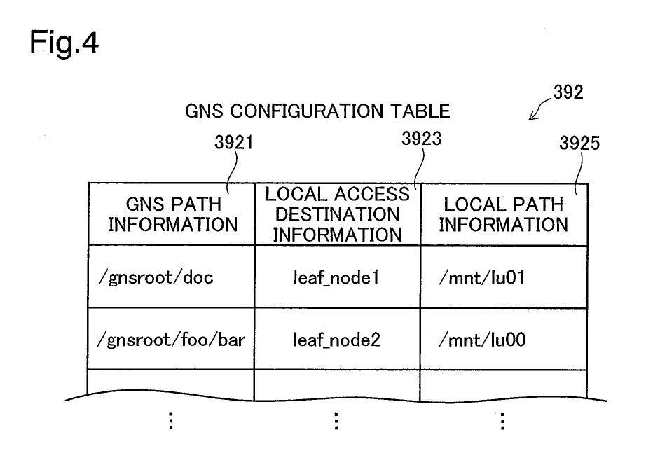

FIG. 4 is an illustration depicting an exemplary GNS configuration table 392 managed by the root node 30. The GNS configuration table 392 of the root node 30 includes GNS path information 3921 specifying global paths that indicate locations of the volumes 690 on the global name space, local access destination information 3923 identifying locations of the leaf nodes 50 that manage the volumes 690 associated with these GNS paths, and local path information 3925 specifying local paths that indicate the locations of the volumes 690 on the local name space.

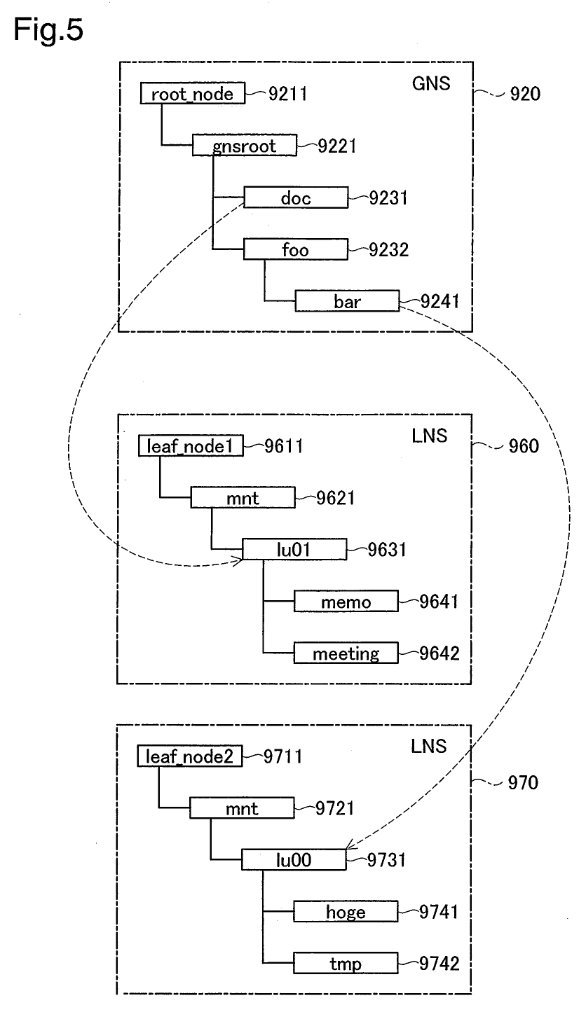

FIG. 5 is an illustration depicting in model form associations between the global name space (GNS) and the local name space (LNS). As shown in FIG. 5, in the present embodiment, a global access destination 9211 named “root_node” on the global name space has been created in association with the root node 30. A global folder 9221 named “gnsroot” is set up below the global access destination 9211. Below this global folder 9221 have been created a global folder 9231 named “doc” and a global folder 9232 named “foo.” A global folder 9231 named “bar” is created below the global folder 9232.

As shown in FIG. 5, in the present embodiment, a local access destination 9611 named “leaf_node1” has been created in association with the leaf node 50 of the storage system 42, on the local name space 960 configured in the storage system 42. A local folder 9621 named “mnt” has been created below the local access destination 9611. A local folder 9631 named “lu01” has been created below the local folder 9621. Below the local folder 9631 have been created a local folder 9641 named “memo” and a local folder 9642 named “meeting.”

As shown in FIG. 5, in the present embodiment, a local access destination 9711 named “leaf_node2” has been created in association with the leaf node 50 of the storage system 44, on the local name space 970 configured in the storage system 44. A local folder 9721 named “mnt” has been created below the local access destination 9711. A local folder 9731 named “lu00” has been created below the local folder 9721. Below the local folder 9731 have been created a local folder 9741 named “hoge” and a local folder 9742 named “tmp.”

According to the GNS configuration table shown in FIG. 4, the global folder 9231 specified by the GNS path “/gnsroot/doc” is associated with the local folder 9631 specified by the local path “/mnt/lu01” managed by the local access destination “leaf_node1”; the global folder 9241 specified by the GNS path “/gnsroot/foolbar” is associated with the local folder 9731 specified by the local path “/mnt/lu00” managed by the local access destination “leaf_node2.”

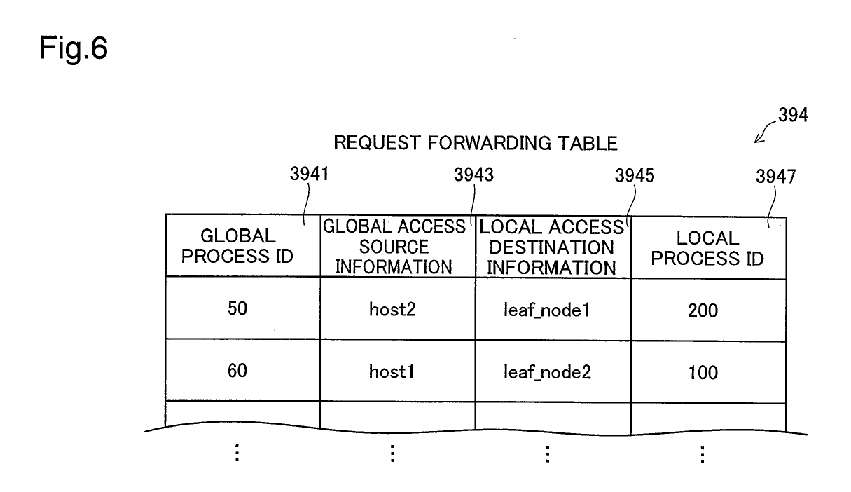

FIG. 6 is an illustration depicting an exemplary request forwarding table 394 managed by the root node 30. The request forwarding table 394 of the root node 30 contains global access origination information 3943 identifying the host computer system 20 issuing an access request over the global name space; a global process ID 3941 indicating an access identification code appended to the access request over the global name space; local access destination information 3945 identifying the leaf node 50 which is the recipient of the access request forwarded over the local name space; and a local process ID indicating an access identification code appended to the access request over the local name space. In the example of FIG. 6, an access request with the global process ID “50” appended is issued over the global space by the host computer system 20 named “host2” originating global access; the local process ID “200” is then appended to the access request, which is then forwarded to the leaf node 50 named “leaf_node1” as the local access destination. In the example of FIG. 6, an access request with the global process ID “60” appended is issued over the global space by the host computer system 20 named “host1” originating global access; the local process ID “2100” is then appended to the access request, which is then forwarded to the leaf node 50 named “leaf_node2” as the local access destination.

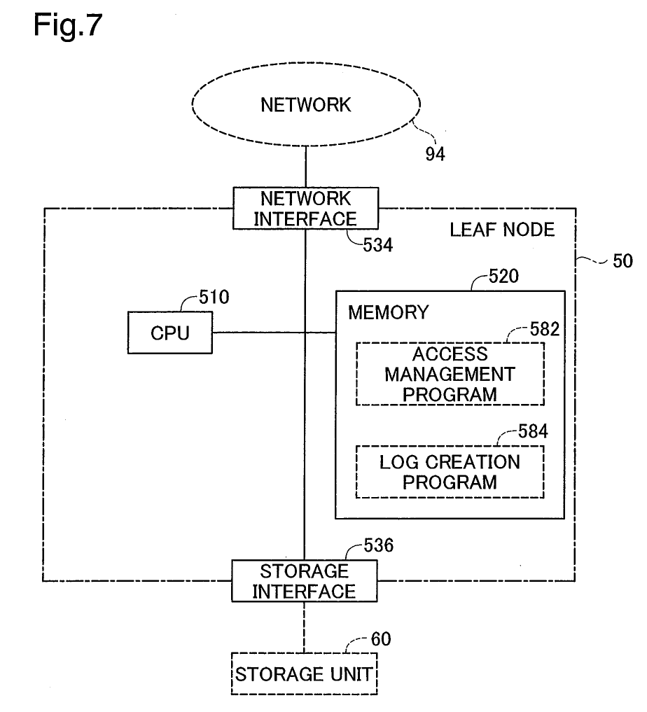

FIG. 7 is an illustration primarily depicting the specific configuration of a leaf node 50 in the computer system 10. The leaf node 50 is a device also termed a file server. The leaf node 50 has a CPU 510 for controlling the various parts of the leaf node 50; a memory 520 for saving data handled by the CPU 510; a network interface 534 for exchange of data via the network 94; and a storage interface 536 for exchange of data with the storage unit 60. The memory 520 of the leaf node 50 stores, as programs for operating the CPU 510, an access management program 582 for managing file access to the volume 690 of the storage unit 60 through the network 94; and a log creation program 584 for creating an access log which records the mode of file access to the volume 690 of the storage unit 60. In the present embodiment, the access log created by the CPU 510 of the leaf node 50 on the basis of the log creation program 584 is recorded using local paths handled over the local name space. The operation of the leaf node 50 will be discussed in detail later.

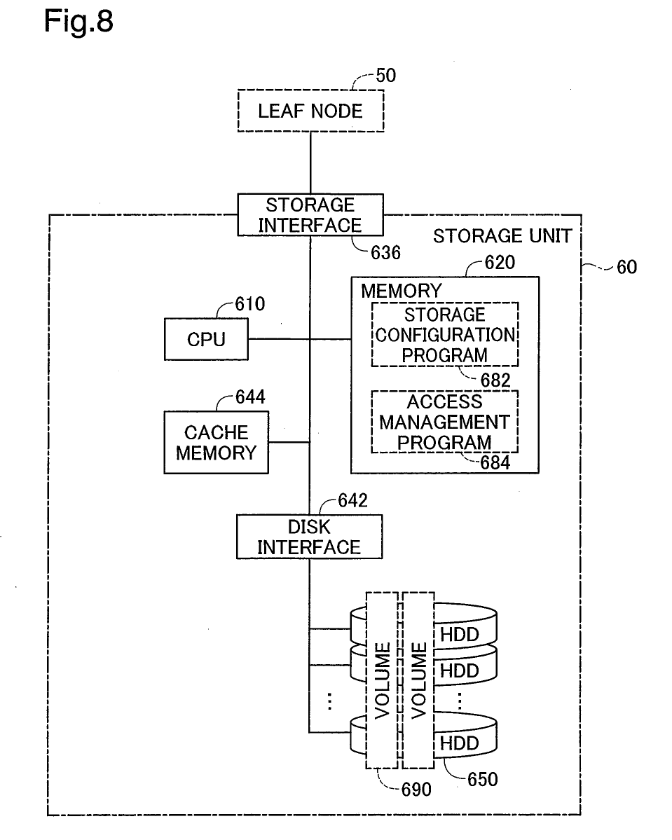

FIG. 8 is an illustration primarily depicting the specific configuration of a storage unit 60 in the computer system 10. The storage unit 60 has a CPU 610 for controlling the various parts of the storage unit 60; a memory 620 for saving data handled by the CPU 610; a storage interface 636 for exchange of data with the leaf node 50; a plurality of hard disk drives (HDD) 650; a disk interface 642 for exchange of data with the plurality of HDD 350; and a cache memory 644 for temporarily saving data exchanged between the storage interface 636 and the disk interface 642.

The memory 620 of the storage unit 60 stores, as programs for operating the CPU 610, a storage configuration program 682 and an access management program 684. In the present embodiment, the volume 690 of the storage unit 60 is logically configured by means of management of the plurality of HDD 650 by RAID (Redundant Arrays of Independent (Inexpensive) Disks) technology, by the CPU 610 in accordance with the storage configuration program 682 using the memory 620. The storage devices that make up the volume 690 are not limited to HDD, and it would be acceptable to instead use semiconductor memory, or a combination of HDD and semiconductor memory.

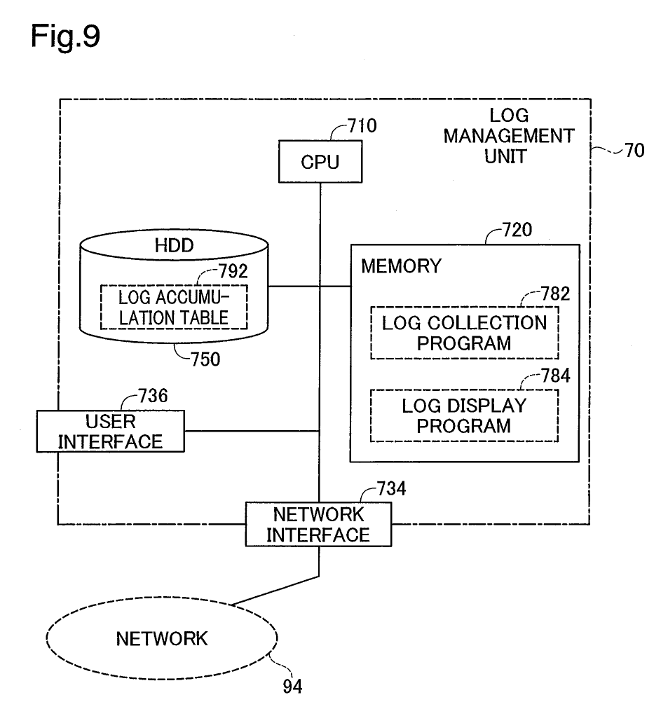

FIG. 9 is an illustration depicting in detail the log management unit 70 in the computer system 10. The log management unit 70 has a CPU 710 for controlling the various parts of the log management unit 70; a memory 720 for saving data handled by the CPU 710; a hard disk drive (HDD) 750 for storing data saved in the memory 720; a network interface 734 for exchange of data via the network 94; and a user interface 736 for exchange of data with the administrator of the computer system 10. In the present embodiment, the user interface 736 of the log management unit 70 includes a keyboard and mouse for accepting input from the administrator, and a display for displaying images to the administrator. In the HDD 750 of the log management unit 70 there is stored a log accumulation table 792 containing accumulated access logs that were processed in the computer system 10. The memory 720 of the log management unit 70 stores, as programs for operating the CPU 710, a log collection program 782 for collecting access logs via the network interface 734 and storing them in the log accumulation table 792; and a log display program 784 for displaying access logs that have been accumulated in the log accumulation table 792. In the present embodiment, on the basis of instruction input from the user interface 736 the log management unit 70 displays the access logs that have been accumulated in the log accumulation table 792, on the display of the user interface 736. As another embodiment, the access logs accumulated in the log accumulation table 792 of the log management unit 70 could be displayed on the display of the host computer system 20 having access to the log management unit 70, or of some other device.

A2. Computer System Operation:

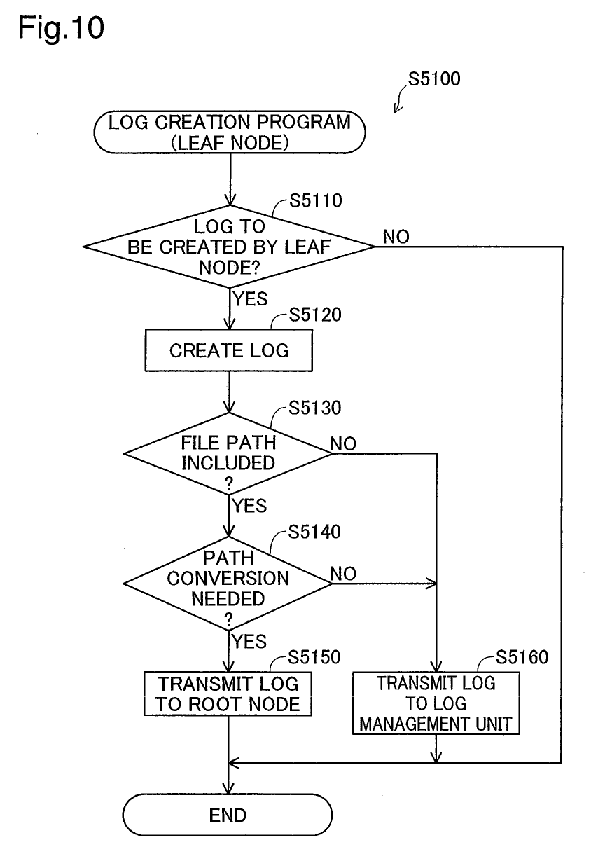

FIG. 10 is a flowchart depicting a log creation process (Step S5100) executed by the leaf node 50 in the computer system 10. In the present embodiment, the log creation process of FIG. 10 (Step S5100) is implemented through software-controlled operation of the CPU 510 of the leaf node 50. In the present embodiment, the leaf node 50 initiates the log creation process of FIG. 10 (Step S5100), in the event that file access to a volume of the storage unit 60 via the leaf node 50 has been processed.

Once the log creation process of FIG. 10 (Step S5100) has been initiated, the leaf node 50 decides whether it is necessary to create an access log on the leaf node 50 in relation to file access that was handled by the leaf node 50 (Step S5110). For example, in the event that an access log relating to the file access in question will be created by the root node 30, there will be no need to create an access log on the leaf node 50.

If the leaf node 50 decides that it is necessary to create an access log (Step S5110), it creates an access log recording execution of file access handled by the leaf node 50 (Step S5120).

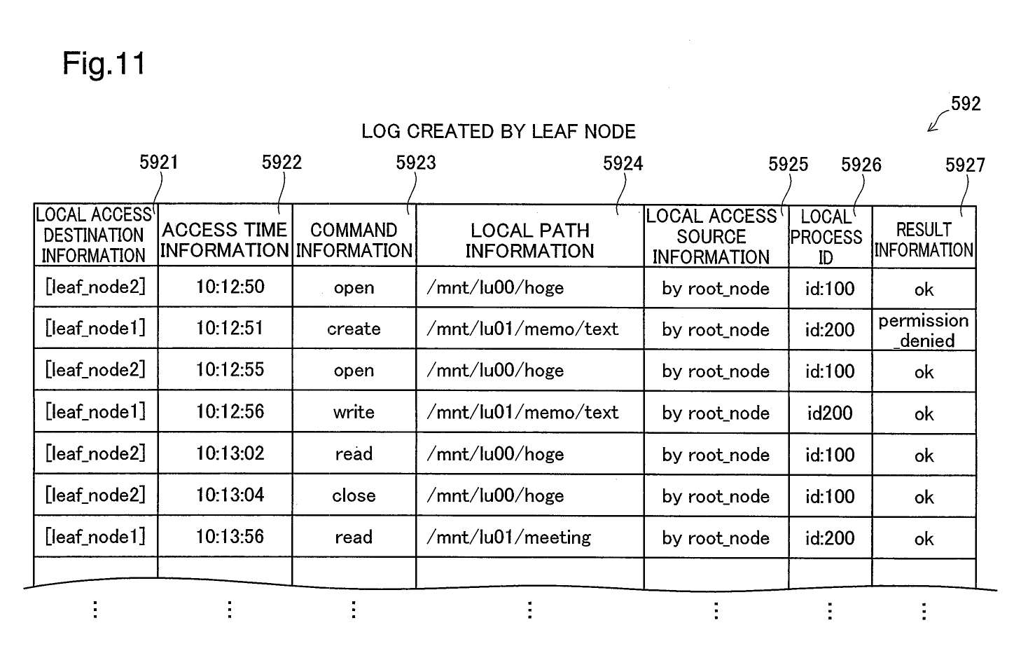

FIG. 11 is an illustration depicting an exemplary access log 592 created by the leaf node 50. The access log 592 contains local access destination information 5921, access time information 5922, command information 5923, local path information 5924, local access source information 5925, a local process ID 5926, and result information 5927. The local access destination information 5921 in the access log 592 includes information that identifies the leaf node 50 which is the destination for transfer of the access request over the local name space. The access time information 5922 in the access log 592 includes information indicating the time at which the access request was processed. The command information 5923 in the access log 592 includes information indicating the process function specified by the access request. For example, where the command information 5923 indicates “open,” this indicates a process function of enabling file access; “create” indicates a process function of creating a new file; “write” indicates a process function of writing data to a file; and “read” indicates a process function of reading data from a file. The local path information 5924 in the access log 592 indicates the local path specified in the access request. The local access source information 5925 in the access log 592 includes information that identifies the source root node 30 which forwarded the access request over the local name space. The local process ID 5926 in the access log 592 includes information that indicates the local process ID appended to the access request. The result information 5927 in the access log 592 includes information indicating whether the access request was executed normally.

Returning to FIG. 10, after the access log has been created (Step S5120), in the event that the access log includes a local path (Step S5130) and it is necessary to convert the local path of the access log into a GNS path (Step S5140), the leaf node 50 will transmit the access log to the root node 30 (Step S5150). For example, since all of the entries in the access log 592 include the local path as the local path information 5924, after they have been created they will be transmitted to the root node 30.

If on the other hand, the created access log does not contain a local path (Step S5130), or in instances where it has been preestablished that the created access log is of a type that does not require path conversion (Step S5140), the leaf node 50 will transmit the access log to the log management unit 70 (Step S5160). In the present embodiment, once the log management unit 70 receives the access log from the leaf node 50, it stores the access log in the log accumulation table 792.

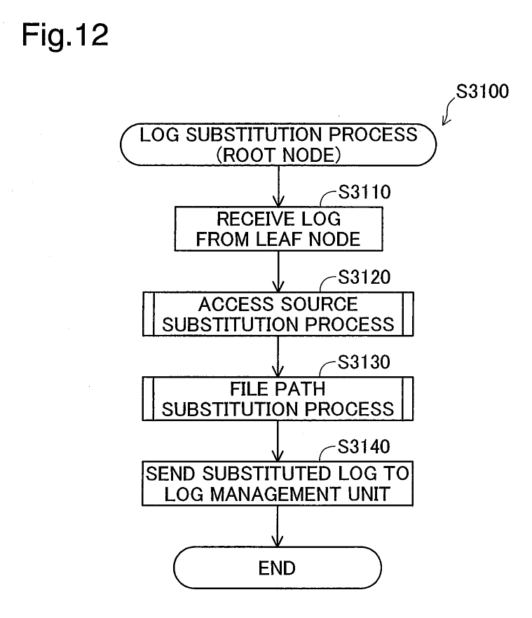

FIG. 12 is a flowchart depicting a log substitution process (Step S3100) executed by the root node 30 in the computer system 10. In the present embodiment, the log substitution process of FIG. 12 (Step S3100) is implemented through software-controlled operation of the CPU 310 of the root node 30. In the present embodiment, the root node 30 initiates the log substitution process of FIG. 12 (Step S3100) in the event that the leaf node 50 has sent the access log 592 to the root node 30 (Step S5150),

Once the log substitution process of FIG. 12 (Step S3100) has been initiated, the root node 30 receives the access log 592 from the leaf node 50 (Step S3110). Thereafter, by means of executing an access source substitution process (Step S3120) and a file path substitution process (Step S3130), the root node 30 replaces the information relating to the local name space contained in the access log 592 sent by the leaf node 50, with information relating to the global name space. In the access source substitution process (Step S3120), the local access source information 5925 and the local process ID 5926 contained in the access log 592 that was received from the leaf node 50 are replaced with information on the global name space. In the file path source substitution process (Step S3130), the local access destination information 5921 and the local path information 5924 contained in the access log 592 that was received from the leaf node 50 are replaced with information on the global name space. After the access source substitution process (Step S3120) and the file path source substitution process (Step S3130), the root node 30 transmits to the log management unit 70 the access log in which the information relating to the local name space has been replaced (Step S3140). In the present embodiment, upon receiving the access log from the root node 30, the log management unit 70 stores the access log in the log accumulation table 92.

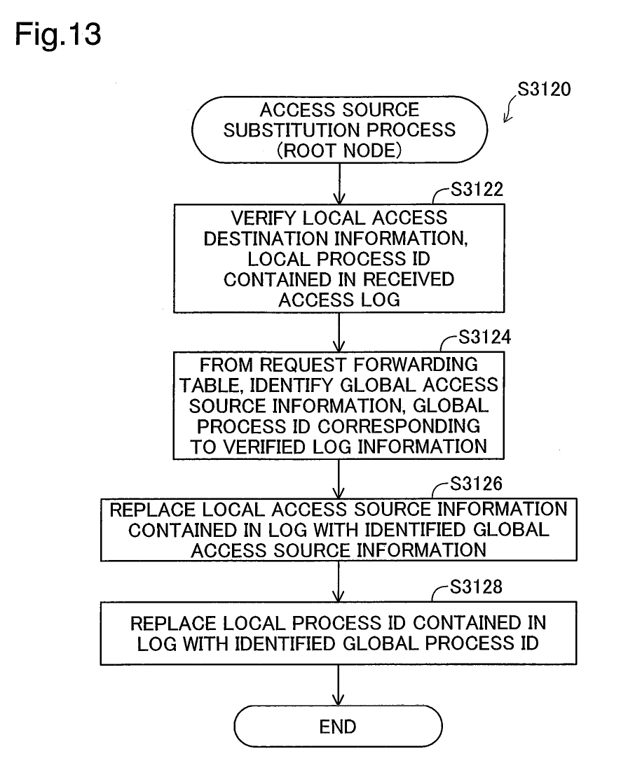

FIG. 13 is a flowchart depicting the access source substitution process (Step S3120) executed by the root node 30 in the computer system 10. Once the access source substitution process shown in FIG. 13 (Step S3120) is initiated, the root node 30 verifies the local access destination information 5921 and the local process ID 5926 contained in the access log 592 that was received from the leaf node 50 (Step S3122). The root node 30 then searches the entries in the request forwarding table 394 for ones matching the information contained in the local access destination information 5921 and the local process ID 5926 that were verified in the access log 592, and identifies from the request forwarding table 394 the global access source information 3943 and the global process ID 3941 associated with these entries (Step S3124). The root node 30 then replaces the local access source information 5925 contained in the access log 592 that was received from the leaf node 50, with the information contained in the global access source information 3943 identified from the request forwarding table 394 (Step S3126), as well as replacing the local process ID 5926 contained in the access log 592 that was received from the leaf node 50 with the information contained in the global process ID 3941 identified from the request forwarding table 394 (Step S3128).

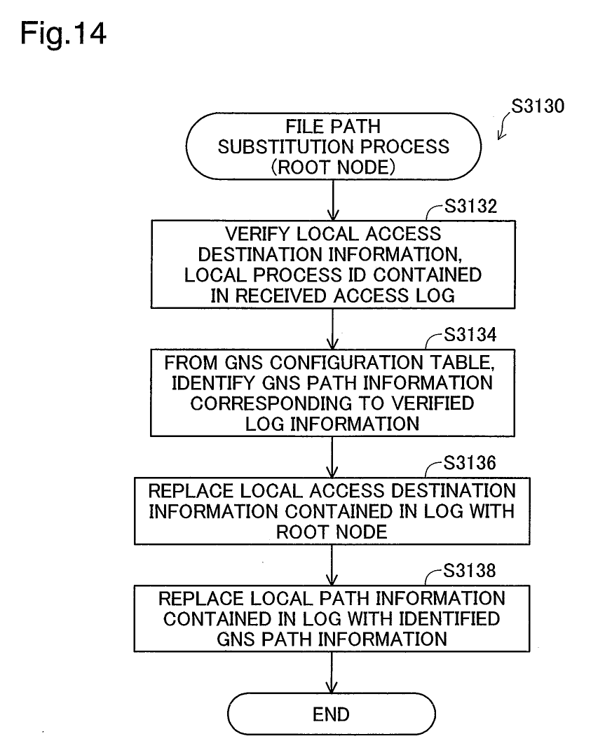

FIG. 14 is a flowchart depicting the file path substitution process (Step S3130) executed by the root node 30 in the computer system 10. Once the file path substitution process shown in FIG. 14 (Step S3130) is initiated, the root node 30 verifies the local access destination information 5921 and the local path information 5924 contained in the access log 592 contained in the access log 592 that was received from the leaf node 50 (Step S3132). The root node 30 then searches the entries in the GNS configuration table 392 for ones matching the information contained in the local access destination information 5921 and the local path information 5924 that were verified in the access log 592, and identifies from the GNS configuration table 392 the GNS path information 3921 associated with the entries (Step S3134). The root node 30 then replaces the local access destination information 5921 contained in the access log 592 that was received from the leaf node 50, with information indicating the location of the root node 30 in the global name space (Step S3136), as well as replacing the local path information 5924 contained in the access log 592 that was received from the leaf node 50, with the information contained in the GNS path information 3921 identified from the GNS configuration table 392 (Step S3138).

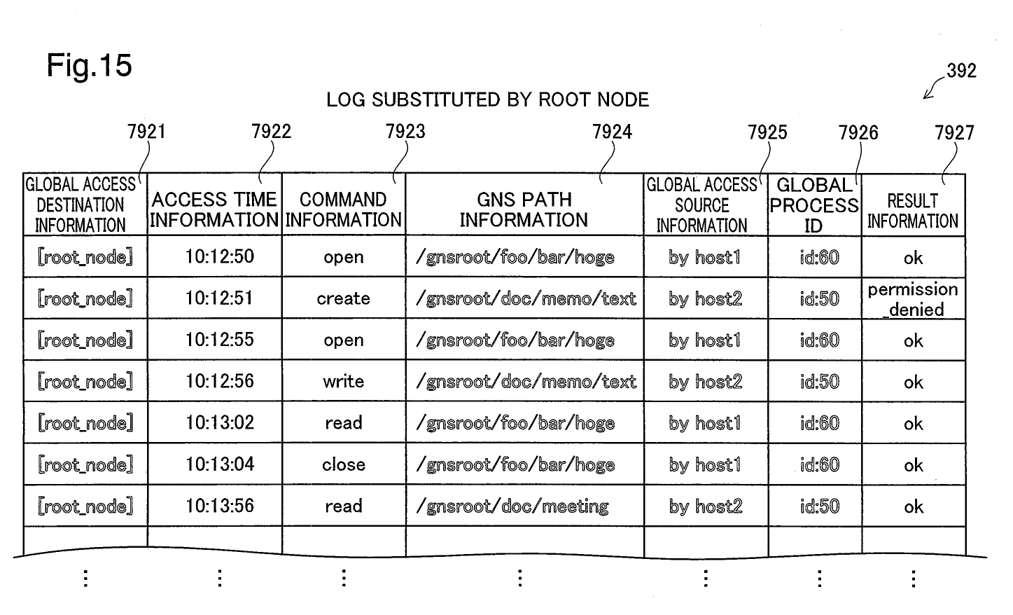

FIG. 15 is an illustration depicting an example of an access log 392 that has been substituted by the root node 30. The access log 392 of FIG. 15 is a log derived by processing of the access log 592 shown in FIG. 11, by the access source substitution process (Step S3120) and the file path substitution process (Step S3130). The access log 392 includes global access destination information 7921, access time information 7922, command information 7923, GNS path information 7924, global access source information 7925, a global process ID 7926, and result information 7927. The global access destination information 7921 of the access log 392 includes the information that was substituted for the local access destination information 5921 in the access log 592 by the file path substitution process (Step S3130). The access time information 7922 of the access log 392 contains information similar to the access time information 5922 of the access log 592. The command information 7923 of the access log 392 contains information similar to the command information 5923 of the access log 592. The GNS path information 7924 of the access log 392 contains the information that was substituted for the local path information 5924 of the access log 592 by the file path substitution process (Step S3130). The global access source information 7925 of the access log 392 contains the information that was substituted for the local access destination information 5925 of the access log 592 by the access destination substitution process (Step S3120). The global process ID 7926 of the access log 392 contains the information that was substituted for the local process ID 5926 of the access log 592 by the access destination substitution process (Step S3120). The result information 7921 of the access log 392 contains information similar to the result information 5927 of the access log 592.

A3. Effects:

According to the computer system 10 discussed hereinabove, since the access log 392 displayed by the log management unit 70 is one that has been converted from local paths to global paths, the process of analyzing the access log in the global name space using global paths can be carried out easily. Moreover, since the access log 392 that has been converted from local paths to global paths has been accumulated in the log accumulation table 792 of the log management unit 70 prior to display of the log, the speed of response to a log display request can be improved. Furthermore, since conversion of the access log from local paths to global paths is executed by the root node 30 that manages associations between local paths to global paths, processing efficiency in the computer system 10 can be improved.

### B. Embodiment 2

The computer system in Embodiment 2 is similar to the computer system 10 of Embodiment 1, except that all access logs created by the leaf nodes 50 are transmitted directly to the log management unit 70 without going through the root node 30, for storage in the log accumulation table 792 of the log management unit 70.

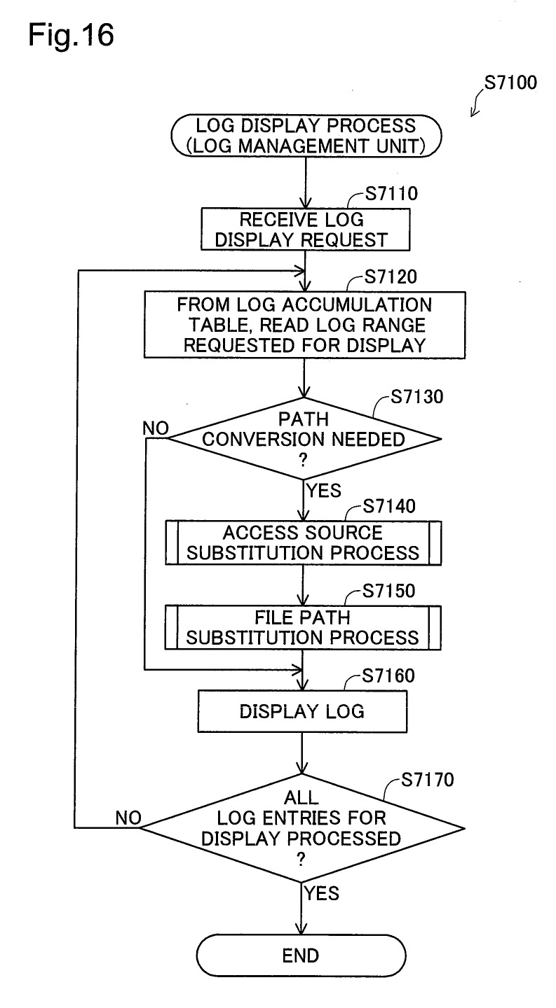

FIG. 16 is a flowchart depicting a log display process (Step S7100) executed by the log management unit 70 in Embodiment 2. In the present embodiment, the log display process of FIG. 16 (Step S7100) is implemented through software-controlled operation of the CPU 710 of the log management unit 70. The log management unit 70 initiates the log display process of FIG. 16 (Step S7100) in the event that the administrator of the log management unit 70 requests log display through the user interface 736.

When the log display process of FIG. 16 (Step S7100) is initiated, the log management unit 70 receives the log display request from the administrator via the user interface 736 (Step S7110). The log management unit 70 then reads out from the log accumulation table 792 the range of access log entries specified in the log display request which it has received (Step S7120). Subsequently, in the event it is necessary to convert the information relating to the local name space included in the access log that was read from the log accumulation table 792, to information relating to the global name space (Step S7130), the log management unit 70 will execute an access source substitution process (Step S7140) and a file path substitution process (Step S7150), then display the access log on the display via the user interface (Step S7160). If on other hand conversion of the access log is not necessary (Step S7130), the log management unit 70 will display on the display the unmodified access log read out from the log accumulation table 792 (Step S7170). Instances in which modification of the access log is not necessary (Step S7130) could include, for example, where the access log contains no file paths (e.g. when acquiring file system attributes, or switching the file forwarding mode), or where an access log has been created for the system administrator (e.g. a wiring fault between devices, a power fault, etc.). The access source substitution process (Step S7140) and the file path substitution process (Step S7150) are similar to the access source substitution process (Step S3120) and the file path substitution process (Step S3130), except that they are executed by the log management unit 70 instead of the root node 30. In the present embodiment, in order to execute the source substitution process (Step S7140) and the file path substitution process (Step S7150), the log management unit 70 collects information contained in the logs in order to create tables similar to the GNS configuration table 392 and the request forwarding table 394 managed by the root node 30, and stores these tables in the HDD 750.

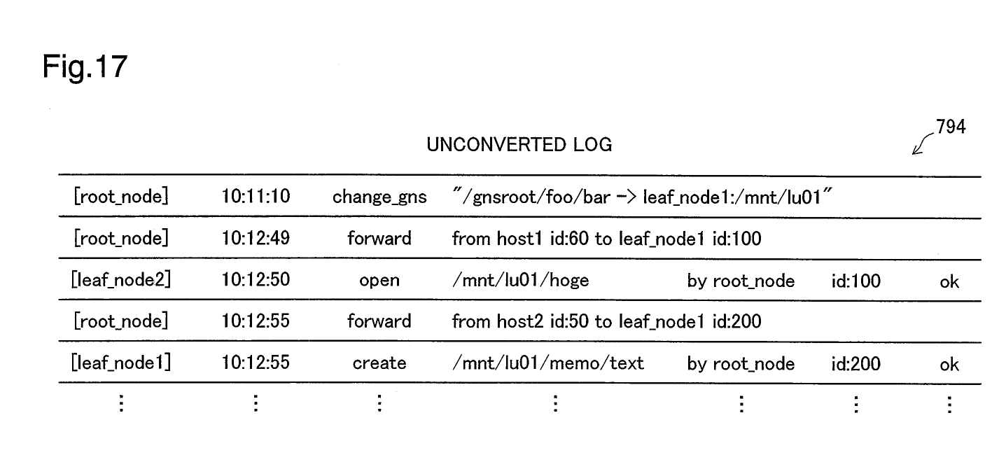

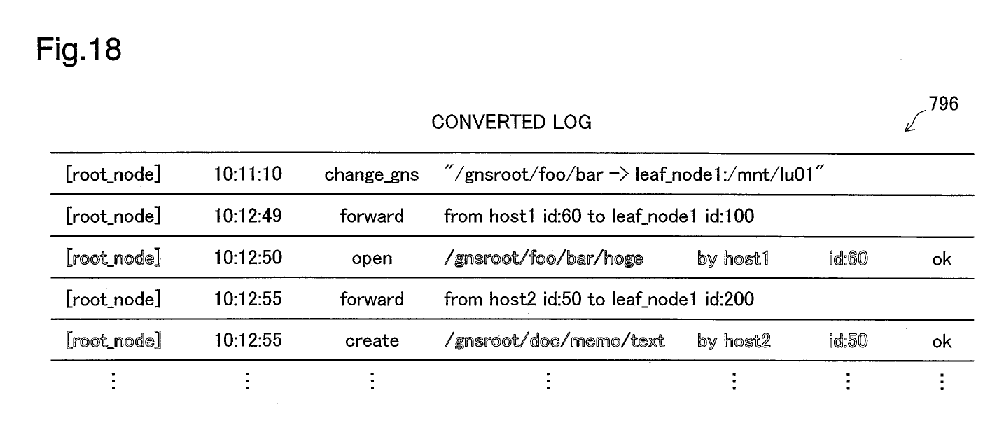

FIG. 17 is an illustration depicting an example of an unconverted log 794 accumulated in the log accumulation table 792 of the log management unit 70 in Embodiment 2. FIG. 18 is an illustration depicting a converted log 796 derived by conversion from the unconverted log 794 of FIG. 17, by the log display process (Step S7100). In the present embodiment, the log management unit 70 creates a table similar to the GNS configuration table 392, from the log entry relating to the command “change_gns” shown in the first row of FIG. 17. In the present embodiment, the log management unit 70 creates a table similar to the request forwarding table 394, from the log entries relating to the command “forward” shown in the second and fourth rows of FIG. 17. In the present embodiment, the log entries relating to the command “change_gns” and the command “forward” are handled as log entries for which path conversion is unnecessary in the log display process (Step S7100), and are displayed as-is without conversion, as shown in the converted log 976 of FIG. 18.

According to the computer system in Embodiment 2 discussed hereinabove, since conversion of the access log from local paths to global paths is executed in response to a log display request (Step S7100), the processing load on the computer system during execution of file access can be reduced.

### C. Other Embodiments

While the invention has been described hereinabove in terms of certain preferred embodiments, the invention is in no way limited to these, and may be reduced to practice in various other ways without departing from the spirit thereof.

The access display unit may include: a post-conversion log accumulation unit for cumulating the access log converted from the local path to the global path by the access log conversion unit; and a accumulated log display unit that displays the access log accumulated in the post-conversion log accumulation unit, in response to a request for displaying the accumulated access log. According the computer system described above, an access log converted from local paths to global paths is accumulated prior to log display, whereby the speed of response to a log display request can be improved.

The access log conversion unit may include: a pre-conversion log accumulation unit for cumulating the access log received by the access log reception unit; and a accumulated log conversion unit that converts the local path used in the access log accumulated in the pre-conversion log accumulation unit, into the global path associated, by the path configuration unit, with the local path used in the accumulated access log. According the computer system described above, conversion of the access log from local paths to global paths is executed in response to a log display request, whereby it is possible to reduce the processing load on the computer system during execution of file access.

The computer system may further comprise a root node that is connected to the host computer system and constitutes the access path conversion unit, and the path configuration unit, the access log reception unit, and the access log conversion unit may be disposed in the root node. According the computer system described above, conversion of the access log from local paths to global paths is executed by a root node that manages the associations between local paths and global paths, whereby processing efficiency in the computer system can be improved.

The storage system may include: a storage unit for storing the file; and a leaf node that manages file storage in the storage unit; and the leaf node may include: a log creation unit that creates the access log using a local path; and a log forwarding unit that forwards the access log created by the log creation unit to the access log reception unit. According the computer system described above, conversion of the access log from global paths to local paths can be accomplished even in a storage system composed of storage units and leaf nodes.

The access path conversion unit may convert an access request source appended to the file access, from the host computer system to the access path conversion unit, in addition to converting the global path used in the file access into the local path; and the access log conversion unit may convert an access request source recorded in the access log from the access path conversion unit to the host computer system, in addition to converting the local path used in the access log into the global path. According the computer system described above, while processing file accesses on the storage system end using the real access requesters, it is nevertheless possible to create an access log that records the host computer system as the access requester.

The access path conversion unit may convert an access identification code appended to the file access, from a first identification code to a second identification code, in addition to converting the global path used in the file access into the local path; and the access log conversion unit may convert an access identification code recorded in the access log from the second identification code to the first identification code, in addition to converting the local path used in the access log into the global path. According the computer system described above, while processing file accesses on the storage system end using identification codes over local paths, it is nevertheless possible to create an access log using identification codes over global paths.

Although the invention has been described and illustrated in detail, it is clearly understood that the same is by way of illustration and example only and is not to be taken by way of limitation, the spirit and scope of the invention being limited only by the terms of the appended claims.

What is claimed is:

1. A computer system comprising:
a storage system for storing data as a file;
a host computer system that performs file access to the storage system;
a path configuration unit that associates a local path with a global path, wherein the local path represents a location of the file stored in the storage system, and the global path represents a virtual location of the stored file to the host computer system;
an access path conversion unit that converts a global path used in the file access from the host computer system, into a local path associated, by the path configuration unit, with the global path used in the file access, and forwards the converted file access to the storage system;
an access log reception unit that receives an access log using the local path from the storage system after the converted file access is forwarded to the storage system, wherein the access log represents execution record of the forwarded file access;
an access log conversion unit that converts the local path used in the access log received by the access log reception unit, into a global path associated, by the path configuration unit, with the local path used in the received access log; and
an access log display unit that displays the access log converted from the local path into the global path by the access log conversion unit.

2. The computer system according to claim 1,
wherein the access display unit includes:
a post-conversion log accumulation unit for cumulating the access log converted from the local path to the global path by the access log conversion unit; and
a accumulated log display unit that displays the access log accumulated in the post-conversion log accumulation unit, in response to a request for displaying the accumulated access log.

3. The computer system according to claim 1,
wherein the access log conversion unit includes:
a pre-conversion log accumulation unit for cumulating the access log received by the access log reception unit; and
a accumulated log conversion unit that converts the local path used in the access log accumulated in the pre-conversion log accumulation unit, into the global path associated, by the path configuration unit, with the local path used in the accumulated access log.

4. The computer system according to claim 1,
the computer system further comprising a root node that is connected to the host computer system and constitutes the access path conversion unit,
wherein the path configuration unit, the access log reception unit, and the access log conversion unit are disposed in the root node.

5. The computer system according to claim 1, wherein the storage system includes:
a storage unit for storing the file; and
a leaf node that manages file storage in the storage unit; and
wherein the leaf node includes:
a log creation unit that creates the access log using a local path; and
a log forwarding unit that forwards the access log created by the log creation unit to the access log reception unit.

6. The computer system according to claim 1, wherein:
the access path conversion unit converts an access request source appended to the file access, from the host computer system to the access path conversion unit, in addition to converting the global path used in the file access into the local path; and
the access log conversion unit converts an access request source recorded in the access log from the access path conversion unit to the host computer system, in addition to converting the local path used in the access log into the global path.

7. The computer system according to claim 1, wherein:
the access path conversion unit converts an access identification code appended to the file access, from a first identification code to a second identification code, in addition to converting the global path used in the file access into the local path; and
the access log conversion unit converts an access identification code recorded in the access log from the second identification code to the first identification code, in addition to converting the local path used in the access log into the global path.

8. A root node relaying file access from a host computer system to a storage system,
the root node comprising:
a path configuration unit that associates a local path with a global path, wherein the local path represents a location of the file stored in the storage system, and the global path represents a virtual location of the stored file to the host computer system;
an access path conversion unit that converts a global path used in the file access from the host computer system, into a local path associated, by the path configuration unit, with the global path used in the file access, and forwards the converted file access to the storage system;
an access log reception unit that receives an access log using the local path from the storage system after the converted file access is forwarded to the storage system, wherein the access log represents execution record of the forwarded file access;
an access log conversion unit that converts the local path used in the access log received by the access log reception unit, into a global path associated, by the path configuration unit, with the local path used in the received access log; and
an access log display unit that displays the access log converted from the local path into the global path by the access log conversion unit.

9. The root node according to claim 8, wherein:
the access path conversion unit converts an access request source appended to the file access, from the host computer system to the access path conversion unit, in addition to converting the global path used in the file access into the local path; and
the access log conversion unit converts an access request source recorded in the access log from the access path conversion unit to the host computer system, in addition to converting the local path used in the access log into the global path.

10. The root node according to claim 8, wherein:
the access path conversion unit converts an access identification code appended to the file access, from a first identification code to a second identification code, in addition to converting the global path used in the file access into the local path; and
the access log conversion unit converts an access identification code recorded in the access log from the second identification code to the first identification code, in addition to converting the local path used in the access log into the global path.

11. A log management method for managing an access log representing execution of file access from a host computer system to a storage system,
the log management method comprising:
(a) storing a path configuration table for associating a local path with a global path, in a root node that relays file access from the host computer system to the storage system, wherein the local path represents a location of the file stored in the storage system, the global path represents a virtual location of the stored file to the host computer system;
(b) converting, on the root node, a global path used in the file access from the host computer system, into a local path associated, by the path configuration table, with the global path used in the file access, to forward the converted file access to the storage system;
(c) receives an access log using the local path from the storage system after the converted file access is forwarded to the storage system, wherein the access log represents execution record of the forwarded file access;
(d) converting the local path used in the received access log, into a global path associated, by the path configuration table, with the local path used in the received access log; and
(e) displaying the access log converted from the local path into the global path.

12. The log management method according to claim 11,
wherein the step (e) includes:
cumulating the access log converted from the local path to the global path; and
displaying the accumulated access log in response to a request for displaying the accumulated access log.

13. The log management method according to claim 11,
wherein the storage system includes:
a storage unit for storing the file; and
a leaf node that manages file storage in the storage unit; and
wherein log management method further comprising:
(f) creating, on the leaf node, the access log using a local path; and
(g) forwarding the created access log to the root node.

14. The log management method according to claim 11, wherein:
the step (b) includes converting an access request source appended to the file access, from the host computer system to the root node, in addition to converting the global path used in the file access into the local path; and
the step (d) includes converting an access request source recorded in the access log from the root node to the host computer system, in addition to converting the local path used in the access log into the global path.

15. The log management method according to claim 11, wherein:
the step (b) includes converting an access identification code appended to the file access, from a first identification code to a second identification code, in addition to converting the global path used in the file access into the local path; and
the step (d) includes converting an access identification code recorded in the access log from the second identification code to the first identification code, in addition to converting the local path used in the access log into the global path.
